(19) United States
(12) Patent Application Publication
(10) Pub. No.: US 2024/0399834 A1
(43) Pub. Date: Dec. 5, 2024

(54) VEHICLE VENT DUCT

(71) Applicant: TOYOTA JIDOSHA KABUSHIKI KAISHA, Toyota-shi (JP)

(72) Inventor: Masayuki OKANO, Toyota-shi (JP)

(73) Assignee: TOYOTA JIDOSHA KABUSHIKI KAISHA, Toyota-shi (JP)

(21) Appl. No.: 18/627,618

(22) Filed: Apr. 5, 2024

(30) Foreign Application Priority Data
Jun. 1, 2023 (JP) 2023-091065

(51) Int. Cl. B60H 1/26; B60H 1/24

(52) U.S. Cl. CPC B60H 1/26; B60H 1/249

(57) ABSTRACT

Vehicle vent duct is attached to the vehicle body, and has a duct body configured to include an opening portion for communicating the vehicle cabin and the outside of the vehicle cabin, and a retaining claw portion provided on the upper edge of the opening, and a valve body that is swingably retained by the retaining claw portion in the duct body and covers the opening, the duct body, the sound insulation wall portion extending from the lower edge of the opening to the outside and upper side of the vehicle is formed.

### CROSS-REFERENCE TO RELATED APPLICATION

This application claims priority to Japanese Patent Application No. 2023-091065 filed on Jun. 1, 2023, incorporated herein by reference in its entirety.

### BACKGROUND

### 1. Technical Field

The present disclosure relates to vehicle vent ducts.

### 2. Description of Related Art

Japanese Unexamined Patent Application Publication No. 2015-171843 (JP 2015-171843 A) discloses a vent duct including a duct body and a valve body. In the vent duct described in JP 2015-171843 A, a mount pin of the duct body is inserted through an insertion hole in the valve body such that the valve body is swingable. In the vent duct described in JP 2015-171843 A, the insertion hole in the valve body is shaped to allow the valve body to swing significantly toward the outside of a vehicle cabin.

### SUMMARY

With the vent duct disclosed in JP 2015-171843 A, however, noise may enter the vehicle cabin as the valve body flaps due to the airflow, vibrations of a vehicle, etc. during traveling of the vehicle. Increasing the mass of the valve body can reduce the flapping of the valve body. However, such an increase in mass may reduce the ventilation performance that is the original function of the vent duct.

In view of the above circumstances, it is an object of the present disclosure to provide a vehicle vent duct that can reduce entry of noise into a vehicle cabin while maintaining its ventilation performance.

A vehicle vent duct according to an aspect of the present disclosure includes
a duct body that is attached to a vehicle body, the duct body including an opening portion that allows communication between inside and outside of a vehicle cabin, and a retaining claw portion provided at an upper edge of the opening portion; and
a valve body swingably retained by the retaining claw portion of the duct body and covering the opening portion, in which
the duct body further includes a sound insulation wall portion extending from a lower edge of the opening portion toward outside of a vehicle and an upper side of the vehicle.

The vehicle vent duct according to the above aspect of the present disclosure includes the duct body that is attached to the vehicle body. The duct body includes the opening portion that allows communication between the inside and outside of the vehicle cabin. The duct body further includes the retaining claw portion provided at the upper edge of the opening portion. The valve body is swingably retained by the retaining claw portion. The opening portion is covered by the valve body. The opening portion is covered by the valve body under no load. It is therefore possible to reduce entry of noise from the outside of the vehicle into the vehicle cabin. When there is a difference in air pressure between the inside of the vehicle cabin and the outside of the vehicle cabin, the valve body swings to temporarily open the opening portion. Air in the vehicle cabin can thus be discharged.

The duct body further includes the sound insulation wall portion extending from the lower edge of the opening portion toward the outside of the vehicle and the upper side of the vehicle. Accordingly, part of sound from the outside of the vehicle toward the duct body can be insulated by the sound insulation wall portion. Entry of the sound into the vehicle can thus be reduced.

In the vehicle vent duct according to the above aspect of the present disclosure,
a stopper that supports the valve body from inside of the vehicle may be provided at the lower edge of the opening portion.

In the vehicle vent duct according to the above aspect of the present disclosure, the stopper supports the valve body from the inside of the vehicle. Therefore, the valve body is less likely to enter the opening portion.

In the vehicle vent duct according to the above aspect of the present disclosure,
the sound insulation wall portion may be curved in a shape that matches a trajectory a lower end of the valve body follows when the valve body swings.

In the vehicle vent duct according to the above aspect of the present disclosure, the sound insulation wall portion is curved in a shape that matches the trajectory of the lower end of the valve body. Clearance between the valve body and the sound insulation wall portion can thus be kept constant when the valve body swings.

In the vehicle vent duct according to the above aspect of the present disclosure,
the duct body may further include a branch wall portion extending from the lower edge of the opening portion toward outside of the vehicle so as to branching off from the sound insulation wall portion.

In the vehicle vent duct according to the above aspect of the present disclosure, the branch wall portion is provided. Therefore, the sound insulation effect can further be enhanced compared to a structure in which sound is insulated only by the sound insulation wall portion.

In the vehicle vent duct according to the above aspect of the present disclosure,
a plurality of the valve bodies and a plurality of the sound insulation wall portions may be arranged in a vertical direction, and
the sound insulation wall portion located at a lower position may be longer than the sound insulation wall portion located at an upper position.

In the vehicle vent duct according to the above aspect of the present disclosure, the sound insulation wall portion located at a lower position is longer than the sound insulation wall portion located at an upper position. It is therefore possible to effectively reduce entry of noise from below, such as road noise, out of noise entering the vehicle cabin. Moreover, since the sound insulation wall portion located at an upper position is relatively short, it is possible to maintain ventilation performance.

As described above, according to the vehicle vent duct of the present disclosure, it is possible to reduce entry of noise into a vehicle cabin while maintaining its ventilation performance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle to which a vehicle vent duct according to a first embodiment is applied as viewed from a rear side;

FIG. 2 is a perspective view of the vehicle vent duct according to the first embodiment, and is a view showing a state in which the valve body is not attached;

FIG. 3 is an enlarged sectional view taken along III-III line of FIG. 2;

FIG. 4A is an enlarged cross-sectional view of a main part of a vehicle vent duct according to a first embodiment;

FIG. 4B is an enlarged cross-sectional view of a main part of a vehicle vent duct according to a comparative example;

FIG. 5A is an enlarged sectional view of a main part of a vehicle vent duct according to a first modification;

FIG. 5B is an enlarged cross-sectional view of a main part of a vehicle vent duct according to a second modification; and

FIG. 6 is an enlarged sectional view of a main part of the vehicle vent duct according to a second embodiment.

### DETAILED DESCRIPTION OF EMBODIMENTS

### First Embodiment

Hereinafter, a vehicle vent duct 10 according to a first embodiment will be described with reference to the drawings. Note that an arrow UP appropriately shown in the drawings indicates an upper side of the vehicle. The arrow FR shown in the drawings indicates the front side of the vehicle. An arrow LH appropriately shown in the drawings indicates the left side in the vehicle-width direction (left-right direction). Further, in the following description, when the front-rear, up-down, and left-right directions are used without any specific mention, it is assumed that the front-rear direction of the vehicle front-rear direction, the up-down direction of the vehicle up-down direction, and the left-right direction of the vehicle traveling direction are indicated.

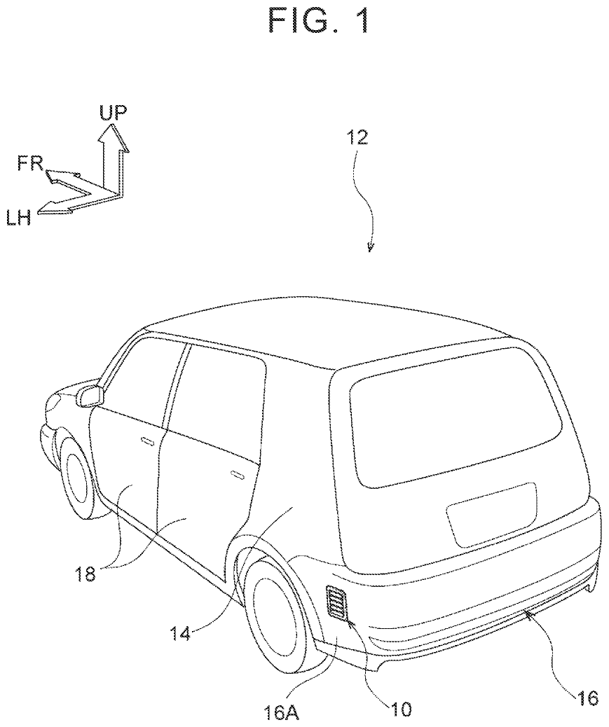

FIG. 1 is a rear perspective view of a vehicle 12 to which a vehicle vent duct 10 according to an embodiment is applied. As shown in FIG. 1, the vehicle vent duct 10 (hereinafter, referred to as a “vent duct 10” as appropriate) of the present embodiment is a quarter vent duct provided on the rear side portion of the vehicle (vehicle body) 12. Specifically, the vent duct 10 is provided in a water panel 14 that constitutes a part of the vehicle body outer plate of the vehicle 12 and separates the vehicle cabin from the outside of the vehicle cabin.

The vent duct 10 is covered with a portion 16A of the rear bumper cover 16 on the vehicle-width-direction outer side. However, for convenience of explanation, FIG. 1 illustrates the vent duct 10 in a state of being visible from the outside of the vehicle. Here, for example, when an air conditioner (not shown) is operated and when the side door 18 is closed, when the pressure in the vehicle interior becomes higher than the pressure outside the vehicle cabin, the air in the vehicle cabin is discharged to the outside of the vehicle cabin through the vent duct 10. In the present embodiment, the vent duct 10 is provided on the left side of the vehicle 12. However, it is not limited thereto. A vent duct 10 may be provided on the right side of the vehicle 12. Vent ducts 10 may be provided on both left and right sides of the vehicle 12. In addition, a vent duct 10 may be provided at another portion of the vehicle 12.

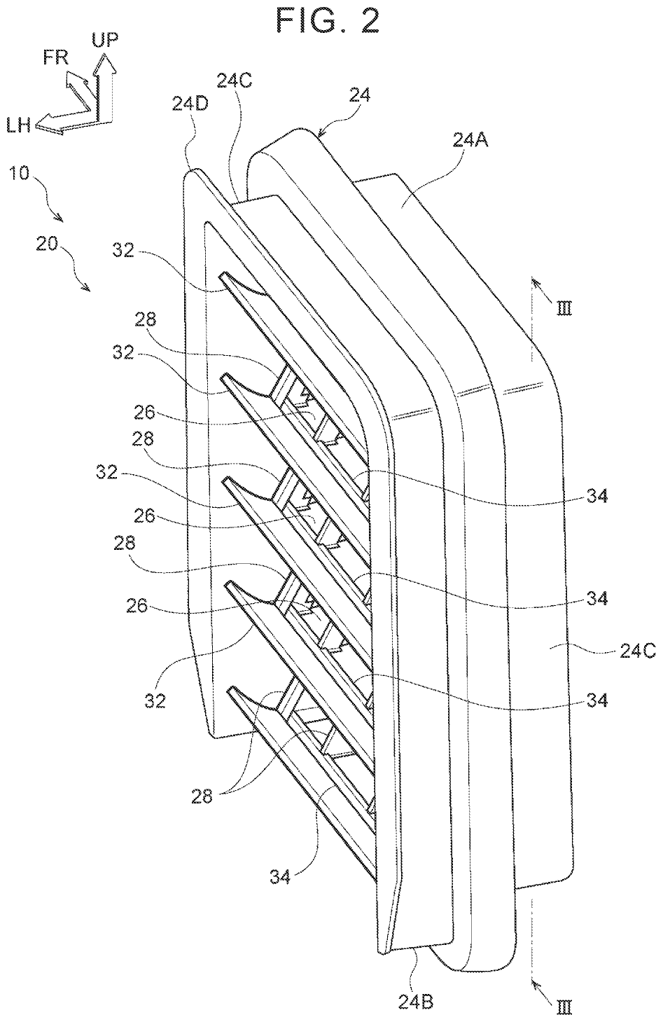

FIG. 2 is a perspective view of the vent duct 10 according to the embodiment. For convenience of explanation, a state in which the valve body 22 is not attached is illustrated. As shown in FIG. 2, the vent duct 10 includes a duct body 20. The duct body 20 is formed of a resin component. The duct body 20 includes a frame 24 whose longitudinal direction is the vehicle vertical direction.

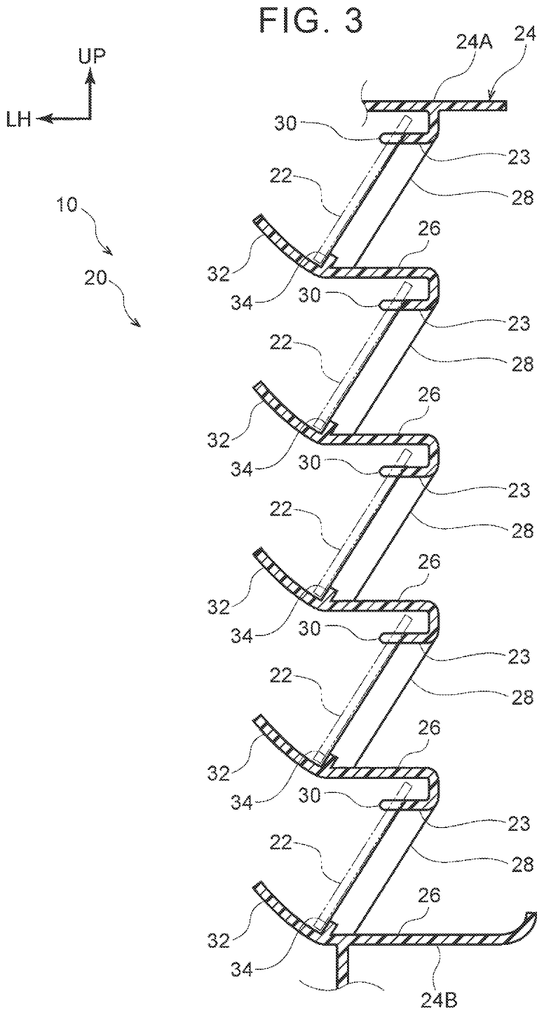

The frame 24 includes an upper wall portion 24A, a lower wall portion 24B, and a pair of side wall portions 24C. The upper wall portion 24A is located at the upper portion and extends in the front-rear direction (the left-right direction in the drawing). The lower wall portion 24B is located at the lower portion and extends in the front-rear direction of the vehicle. The pair of side wall portions 24C connect end portions of the upper wall portion 24A and the lower wall portion 24B to each other. Here, as shown in FIG. 3, an opening portion 23 is formed inside the frame 24. The inside of the vehicle cabin and the outside of the vehicle cabin are communicated with each other by the opening portion 23. The opening portion 23 is closed from the outside of the vehicle cabin by the valve body 22.

FIG. 3 is an enlarged cross-sectional view of a main part taken along III-III line of FIG. 2. As shown in FIGS. 2 and 3, the duct body 20 is provided with a lateral connecting portion 26 connecting the pair of side wall portions 24C of the frame 24. The lateral connecting portions 26 are provided at equal intervals in the vertical direction of the duct body 20. In the present embodiment, as an example, four lateral connecting portions 26 are provided. Therefore, the opening portion 23 is divided into five portions by the upper wall portion 24A, the lower wall portion 24B, and the four lateral connecting portions 26. The vent duct 10 has a structure in which five valve bodies 22 cover the openings portions 23.

Further, the duct body 20 is provided with a plurality of ribs 28 connecting the upper wall portion 24A and the lower wall portion 24B of the frame 24. In the present embodiment, three ribs 28 are provided. The lateral connecting portions 26 are vertically connected by the ribs 28. Each of the ribs 28 is inclined to the left side of the vehicle (outside in the vehicle width direction) from the upper side to the lower side. The rear surface of the valve body 22 is supported by the rib 28.

As shown in FIG. 3, the duct body 20 is provided with a plurality of retaining claw portions 30. The valve body 22 is retained by these retaining claw portions 30. In the present embodiment, as an example, three retaining claw portions 30 are provided on the upper edges of the five opening portions 23. The valve body 22 is retained by the duct body 20 via the three retaining claw portions 30.

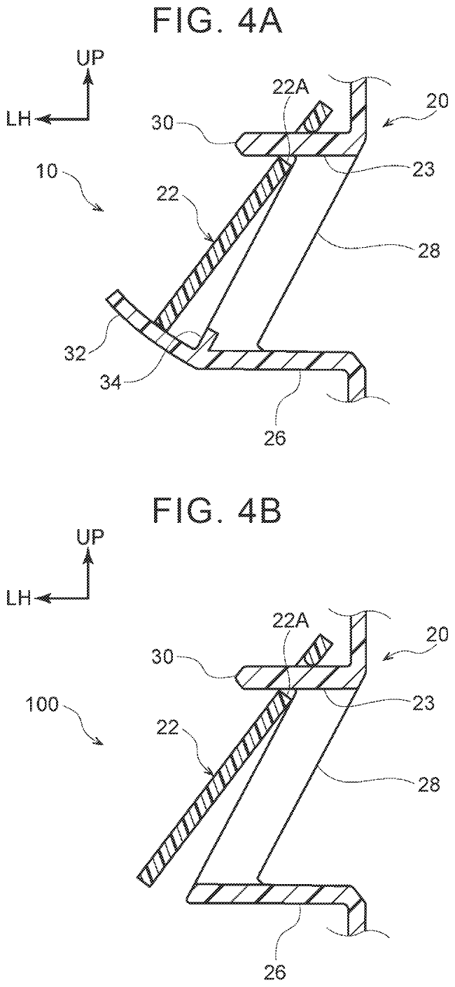

FIG. 4A is an enlarged cross-sectional view of a main part of a vent duct 10. As shown in FIG. 4A, the valve body 22 is made of a flexible material and is formed in a sheet-like shape. In the present embodiment, as an example, the valve body 22 is formed of a rubber sheet. A mount hole 22A penetrating through the thickness is formed in an upper portion of the valve body 22. The size of the mount hole 22A is formed to have substantially the same size as the base end portion of the retaining claw portion 30 in the duct body 20.

The valve body 22 can be attached to the duct body 20 by inserting the mount hole 22A from the distal end of the retaining claw portion 30. Further, the valve body 22 is swingably retained by the retaining claw portion 30 and covers the opening portion 23. Note that, although not shown, a configuration may be adopted in which the distal end of the retaining claw portion 30 is formed to be thicker than the proximal end so that the valve body 22 is less likely to come out.

Here, the duct body 20 is formed with a sound insulation wall portion 32 extending from the lower edge of the opening portion 23 to the vehicle left side (vehicle outside) and the vehicle upper side. Specifically, the sound insulation wall portion 32 is formed in a substantially arc shape curved so as to bulge toward the vehicle outer side and the vehicle lower side. The base end side of the sound insulation wall portion 32 is connected to the front end of the lateral connecting portion 26.

Further, in the present embodiment, the sound insulation wall portion 32 is curved in a shape corresponding to the trajectory of the lower end of the valve body 22 when the valve body 22 swings. Therefore, the gap between the valve body 22 and the sound insulation wall portion 32 is maintained constant when the valve body 22 swings.

Further, a stopper 34 for supporting the valve body 22 from the inside of the vehicle is provided at the lower edge of the opening portion 23. The stopper 34 is formed so as to protrude upward from a boundary portion between the lateral connecting portion 26 and the sound insulation wall portion 32. In the present embodiment, the stopper 34 extends continuously from one side wall portion 24C to the other side wall portion 24C.

### Operations

Next, the operation of the present embodiment will be described.

In the vent duct 10 according to the present embodiment, an opening portion 23 is formed in the duct body 20 to communicate the inside of the vehicle cabin and the outside of the vehicle cabin. A retaining claw portion 30 is provided at an upper edge of the opening portion 23. The valve body 22 is swingably retained by the retaining claw portion 30. The valve body 22 is made of a flexible material. The opening portion 23 is covered by the valve body 22. Thus, in the unloaded state, the opening portion 23 is covered by the valve body 22, so that it is possible to suppress the noise from the outside of the vehicle from entering the vehicle cabin. Further, when an air pressure difference between the inside of the vehicle cabin and the outside of the vehicle cabin occurs, the valve body 22 swings and the opening portion 23 is temporarily opened, so that the air in the vehicle cabin can be discharged.

Further, the duct body 20, the sound insulation wall portion 32 extending from the lower edge of the opening portion 23 to the vehicle outer side and the vehicle upper side is formed. Accordingly, a part of the sound from the outside of the vehicle toward the duct body 20 can be insulated by the sound insulation wall portion 32. Then, it is possible to reduce entry of the sound into the vehicle.

In particular, in the present embodiment, the sound insulation wall portion 32 is curved in a shape corresponding to the trajectory of the lower end of the valve body 22. Therefore, when the valve body 22 swings, the gap between the valve body 22 and the sound insulation wall portion 32 can be kept constant. As a result, the valve body 22 can be stably swung.

In contrast to the comparative example, the above effects are explained. FIG. 4B is an enlarged cross-sectional view of a main part of a vehicle vent duct 100 according to a comparative example. As shown in FIG. 4B, the vehicle vent duct 100 according to the comparative embodiment is different from the vent duct 10 according to the embodiment in that the sound insulation wall portion 32 and the stopper 34 are not provided.

The vehicle vent duct 100 of the comparative example does not include the sound insulation wall portion 32. Therefore, the vehicle vent duct 100 of the comparative example has a structure in which the lower end of the valve body 22 is supported by the lateral connecting portion 26. Here, when the valve body 22 swings and the opening portion 23 is opened, a sound outside the vehicle enters the vehicle cabin from clearance between the valve body 22 and the lateral connecting portion 26. In particular, the sound generated below, such as road noise, enters the vehicle cabin through the opening portion 23 without being blocked by the valve body 22 and the duct body 20.

On the other hand, in the present embodiment, it is possible to shield the sound from the vehicle lower side in particular by the sound insulation wall portion 32. Therefore, it is possible to suppress the entry of noise into the vehicle cabin.

Further, in the present embodiment, by supporting the valve body 22 from the inside of the vehicle by the stopper 34, it is possible to reduce entry of the valve body 22 into the opening portion. That is, in the case of a structure in which the valve body 22 is supported only by the rib 28, it is conceivable that a part of the thin and flexible valve body 22 is deformed and enters the opening portion 23 when a pressure difference occurs between the inside of the vehicle cabin and the outside of the vehicle cabin of the vent duct 10. In the present embodiment, the stopper 34 extends from one side wall portion 24C to the other side wall portion 24C. Therefore, the entire area of the lower end portion of the valve body 22 can be supported. Then, it is possible to effectively suppress the valve body 22 from being deformed and entering into the opening portion 23.

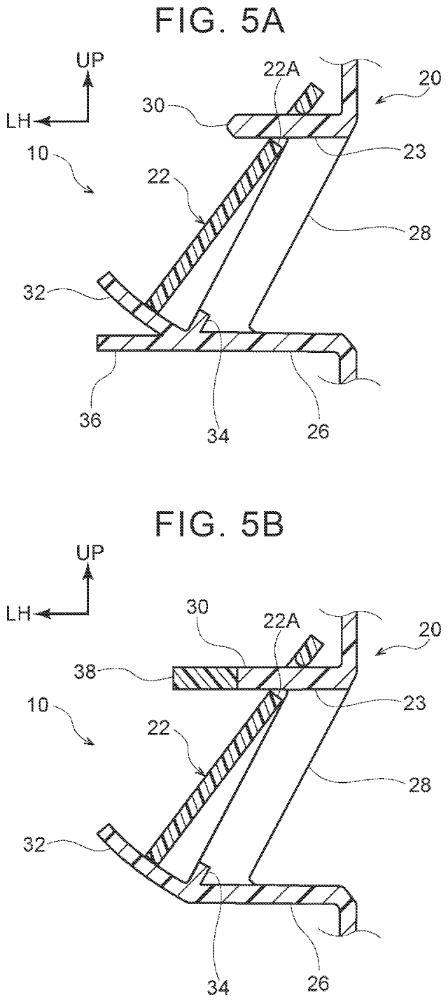

Note that the vent duct 10 is not limited to the configuration illustrated in FIGS. 2 to FIGS. 4A and 4B. Other configurations may be employed as the vent duct 10. For example, the configuration of the modification shown in FIGS. 5A and 5B may be adopted.

### First Modification

FIG. 5A is an enlarged sectional view of a main portion of the vehicle vent duct according to the first modification. As shown in FIG. 5A, in the present modification, the branch wall portion 36 is provided below the sound insulation wall portion 32. The branch wall portion 36 branches off from the sound insulation wall portion 32 and extends outward from the lower edge of the opening portion 23.

In the present embodiment, as an example, the branch wall portion 36 is formed by extending from the front end of the lateral connecting portion 26 to the vehicle left side (vehicle outside). A space is formed between the branch wall portion 36 and the sound insulation wall portion 32.

According to the present modification, since the branch wall portion 36 is provided, the sound insulation effect can be further enhanced as compared with a structure in which the sound insulation wall portion 32 alone insulates sound. Specifically, the sound entering the space between the branch wall portion 36 and the sound insulation wall portion 32 and the sound diffracted from the branch wall portion 36 interfere with each other, so that the effect of suppressing the sound from entering the opening portion 23 is expected. Further, the sound that has entered the space between the branch wall portion 36 and the sound insulation wall portion 32 proceeds to the back while being reflected alternately to the branch wall portion 36 and the sound insulation wall portion 32, an effect of attenuation is expected.

### Second Modification

FIG. 5B is an enlarged sectional view of a main portion of the vehicle vent duct according to the second modification. As shown in FIG. 5B, in the present modification, the deflector 38 extends from the front end of the retaining claw portion 30 to the vehicle left side (vehicle outer side).

For example, the deflector 38 extends to the right side of the vehicle (the inside of the vehicle) rather than the front end of the sound insulation wall portion 32. The deflector 38 is formed integrally with the retaining claw portion 30, for example. The deflector 38 may be separately prepared and attached to the retaining claw portion 30.

According to the present modification, when wind such as traveling wind flows so as to be repelled by the sound insulation wall portion 32 and entrained, it is possible to reduce the entrainment by the deflector 38. Then, it is possible to suppress the flapping of the valve body 22 by the entrained wind. The deflector 38 also narrows the path through which the sound enters the opening portion 23. Therefore, it is possible to suppress the entry of noise.

### Second Embodiment

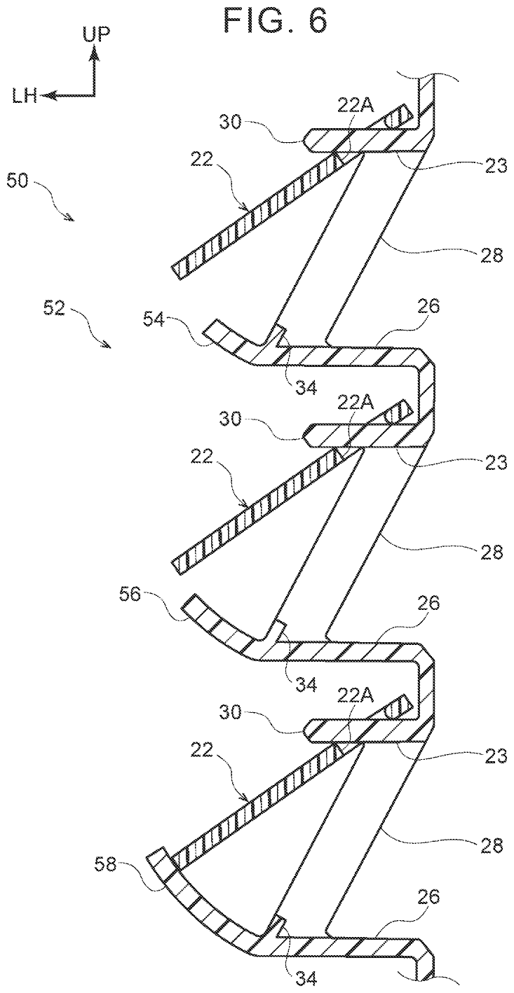

Next, referring to FIG. 6, a vehicle vent duct 50 (hereinafter, referred to as a “vent duct 50” as appropriate) according to the second embodiment will be described. The same components as those in the first embodiment are denoted by the same reference numerals. Descriptions of configurations similar to those of the first embodiment will be omitted as appropriate.

FIG. 6 is an enlarged sectional view of a main part of the vent duct 50 according to the second embodiment. As shown in FIG. 6, the duct body 52 constituting the vent duct 50 of the present embodiment has the same structure as the duct body 20 of the first embodiment except for the sound insulation wall portions 54, 56, and 58.

The sound insulation wall portion 54 is located at an upper portion thereof. The sound insulation wall portion 54 extends from the lower edge of the opening portion 23 to the left side of the vehicle (the vehicle outer side) and the vehicle upper side. The sound insulation wall portion 56 is located below the sound insulation wall portion 54. The sound insulation wall portion 56 extends from the lower edge of the opening portion 23 to the vehicle left side (vehicle outside) and the vehicle upper side. Further, the sound insulation wall portion 58 is located below the sound insulation wall portion 56. The sound insulation wall portion 58 extends from the lower edge of the opening portion 23 to the vehicle left side (vehicle outside) and the vehicle upper side.

Here, the sound insulation wall portion 56 in the central portion is formed longer than the sound insulation wall portion 54 in the upper portion. The sound insulation wall portion 58 below the sound insulation wall portion 56 is formed longer. That is, in the vent duct 50 of the present embodiment, a plurality of valve bodies 22 and a plurality of sound insulation walls are arranged in the vertical direction. The sound insulation wall portion located below the sound insulation wall portion located above is formed longer.

### Operations

Next, the operation of the present embodiment will be described.

In the vent duct 50 according to the present embodiment, the sound insulation wall portions 56 and 58 located below the sound insulation wall portion 54 located above are formed longer. As a result, it is possible to effectively reduce entry of noise from the lower side, such as road noise, out of the noise entering the vehicle cabin, into the vehicle cabin. Conversely, by forming the sound insulation wall portion located above relatively short, the ventilation performance can be maintained. The other effects are the same as those of the first embodiment.

The vent ducts 10 and 50 according to the embodiment and the modification have been described above. However, it should be understood that the present disclosure may be implemented in various forms without departing from the spirit of the present disclosure. In the above embodiment, the duct body 20 is formed of a resin component, and the valve body 22 is formed of a rubber sheet. However, the duct body 20 and the valve body 22 are not limited thereto. The duct body 20 and the valve body 22 may be formed of other materials. For example, at least one of the duct body 20 and the valve body 22 may be formed of a material including a sound absorbing material. Further, for example, the valve body 22 may be formed of a material such as a resin plate.

Further, in the above-described embodiment, as shown in FIG. 3, five valve bodies 22 are arranged in the upper and lower directions, but the present disclosure is not limited thereto. For example, the number of the valve bodies 22 arranged in the upper and lower directions may be four or less, or six or more. In addition, a plurality of valve bodies 22 may be arranged in the vehicle front-rear direction (the left-right direction in the drawing).

Furthermore, in the above embodiment, the sound insulation wall portions 32, 54, 56, 58 are integrally formed with the lateral connecting portion 26 (duct body 20), but the present disclosure is not limited thereto, the sound insulation wall portions 32, 54, 56, 58 may be separately prepared as a structure attached to the lateral connecting portion 26. In this case, if the sound insulation wall portions 32, 54, 56, and 58 are formed to include a material different from the duct body 20, for example, a fiber-based material used as a sound absorbing material, it is possible to effectively suppress the noise from entering the vehicle by absorbing a part of the sound around the duct body 20.

In the above-described embodiment, the sound insulation wall portions 32, 54, 56, and 58 are formed in a substantially arc shape, but the present disclosure is not limited thereto. For example, the sound insulation wall portions 32, 54, 56, and 58 may be formed in a straight line when viewed from the vehicle front-rear direction.

Further, in the above-described embodiment, the stopper 34 is provided. However, the present disclosure is not limited thereto, and the stopper 34 may not be provided as long as the valve body 22 can be stably supported by the rib 28. Further, the shape and length of the rib 28 are not particularly limited.

Furthermore, in the above embodiment, the proximal end portion and the distal end portion of the retaining claw portion 30 are illustrated with the same thickness. However, the present disclosure is not limited thereto, and various shapes may be employed. For example, a structure in which the distal end portion of the retaining claw portion 30 is made thick so that the valve body 22 is less likely to come out may be employed.

With respect to the above embodiments, the following appendices are disclosed.

### APPENDIX 1

The vehicle vent duct includes a duct body and a valve body.

The duct body is attached to the vehicle body and includes an opening portion that communicates the inside of the vehicle cabin with the outside of the vehicle cabin, and a retaining claw portion provided at an upper edge of the opening portion.

The valve body is swingably retained by the retaining claw portion of the duct body and covers the opening portion.

A sound insulation wall portion extending from a lower edge of the opening portion to an outer side of the vehicle and an upper side of the vehicle is formed in the duct body.

### APPENDIX 2

In the vehicle vent duct according to Appendix 1, a stopper for supporting the valve body from the vehicle inside is provided at a lower edge of the opening portion.

### APPENDIX 3

In the vehicle vent duct according to Appendix 1 or 2, the sound insulation wall portion is curved in a shape corresponding to a trajectory of a lower end of the valve body when the valve body swings.

### ADDITIONAL REMARK 4

The vehicle vent duct according to any one of Appendices 1 to 3 includes a branch wall portion branching from the sound insulation wall portion and extending from the lower edge of the opening portion to the outside of the vehicle.

### APPENDIX 5

In the vehicle vent duct according to any one of appendices 1 to 4,

A plurality of the valve body and the sound insulation wall are arranged in the vertical direction,

The sound insulation wall portion located below the sound insulation wall portion located above is formed longer.

What is claimed is:

1. A vehicle vent duct, comprising:
a duct body that is attached to a vehicle body, the duct body including an opening portion that allows communication between inside and outside of a vehicle cabin, and a retaining claw portion provided at an upper edge of the opening portion; and
a valve body swingably retained by the retaining claw portion of the duct body and covering the opening portion, wherein the duct body further includes a sound insulation wall portion extending from a lower edge of the opening portion toward outside of a vehicle and an upper side of the vehicle.

2. The vehicle vent duct according to claim 1, wherein a stopper that supports the valve body from inside of the vehicle is provided at the lower edge of the opening portion.

3. The vehicle vent duct according to claim 1, wherein the sound insulation wall portion is curved in a shape that matches a trajectory a lower end of the valve body follows when the valve body swings.

4. The vehicle vent duct according to claim 1, wherein the duct body further includes a branch wall portion extending from the lower edge of the opening portion toward outside of the vehicle so as to branching off from the sound insulation wall portion.

5. The vehicle vent duct according to claim 1, wherein
a plurality of the valve bodies and a plurality of the sound insulation wall portions are arranged in a vertical direction, and
the sound insulation wall portion located at a lower position is longer than the sound insulation wall portion located at an upper position.
